(19) United States
(12) Patent Application Publication
(10) Pub. No.: US 2007/0065264 A1
(43) Pub. Date: Mar. 22, 2007

(54) SLIDING LOAD FLOOR SYSTEM

(75) Inventors: Alan Sturt, West Bloomfield, MI (US); Artur W. Dlugosz, Sterling Heights, MI (US); James A. Mulvihill, Berkley, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,236

(22) Filed: Sep. 2, 2005

(51) Int. Cl. B60P 1/00

(52) U.S. Cl. 414/545

(57) ABSTRACT

A sliding load floor system for use in the rear cargo area of a vehicle. The cargo area has a pair of opposing side portions that extend longitudinally in relation to the center line of the vehicle. A pair of opposing transverse portions extend laterally in relation to the vehicle. A storage area is positioned between and at a level below a plane including the side and transverse portions. The sliding load floor system comprises a slide mechanism including a pair of opposing rail members having a forward edge, a frame that is slidably received by the rail members of the slide mechanism, a removable load floor that is detachably positioned in relation to the frame; and a hinge assembly that is mounted to the side portions. The forward edges of the rail members are connected to the hinge assembly so that the slide mechanism, the frame and the removable load floor may be displaced upwardly in relation to the hinge assembly, and the frame plus the load floor slid rearwardly and/or arcuately about the hinge assembly.

### BACKGROUND OF THE INVENTION

1. Field of the Invention

The invention relates to a sliding load floor system for the cargo area of a vehicle to allow ergonomic loading and unloading of heavy cargo.

2. Background Art

Today's roads are traveled by full-size pickup trucks, mid-size, and compact vehicles. Typically, they have relatively short rear cargo areas. Abbreviated length restricts the ability of the vehicle operator who wishes to ergonomically transport longer or heavier items that would otherwise be accommodated by vehicles having a longer bed. Tailgate extension devices offer an extended bed floor area. See, e.g., U.S. Pat. Nos. 4,023,850; 4,531,773; and 5,755,480.

To access the rear cargo area, one must first, for example, raise a tailgate or open the rear doors. To retrieve a heavy package located forwardly in the rear cargo area, one must reach over the rear fascia (or rear bumper) area of the vehicle. This may be inconvenient for cleanliness reasons (e.g., the soiling of clothes from a dirty outside vehicle surface). Further, the act of reaching over to retrieve a heavy object may result in back and other physical injury. Similar considerations apply to the act of placing a heavy load into the cargo area from outside the vehicle. Clearly, it would be desirable to avoid the inconvenience of dirtying one's clothing while reducing the chance of back injury.

### SUMMARY OF THE INVENTION

It would be desirable to provide a sliding load floor system that permits heavy cargo items to be loaded and unloaded ergonomically.

Conventionally, the rear cargo area of a vehicle includes a pair of opposing side portions or trim panels that extend longitudinally in relation to the length of the vehicle, a pair of opposing transverse portions that extend laterally, and can include a storage bin positioned between and at a level below the plane of the side and transverse portions.

The sliding load floor system disclosed herein includes a slide mechanism. The slide mechanism includes a pair of opposing rail members. Each rail member has a forward edge and a rearward edge. A frame is slidably received by the slide mechanism.

Detachably attached to the frame is a removable load floor. A hinge assembly is mounted to the side portion of the rear cargo area. The forward edges of the rail members are connected to the hinge assembly. The sliding load floor system of the rail members can be displaced upwardly in relation to the hinge assembly, thereby elevating a level at which the removable load floor can be slid outwardly in relation to the vehicle. In this way, the slide mechanism, the frame and the removable load floor may be moved upwardly, and the frame plus the load floor can be slid rearwardly and/or if desired, moved arcuately about the hinge assembly.

Among the art considered in preparing this patent application are commonly owned U.S. Pat. No. 6,338,518; and WO 0153131 that issued to Mink & Associates Inc.

### BRIEF DESCRIPTION OF THE DRAWINGS

FIG. 1 is a quartering perspective view of a sliding load floor system according to the present invention in an extended position, supporting a load placed thereupon;

FIG. 2 is an exploded view of one embodiment of the present invention;

FIG. 3 depicts a tapered edge flush-fitting sliding load floor system in a closed position;

FIG. 4 depicts a tapered edge flush-fitting sliding load floor system in an extended position;

FIG. 5 is a vertical sectional view through the load floor and frame mechanism illustrating the load floor in a carpet side up configuration;

FIG. 6 is a vertical sectional view through the load floor and frame mechanism illustrating the load floor with its contoured side facing upwardly;

FIG. 7 depicts the frame with various features provided thereupon, one of which is a pair of hinged bicycle attachment brackets;

FIG. 8 is a view of the bicycle front fork attachment with the attachment feature in a raised position;

FIG. 9 is a view of the bicycle front fork attachment with the attachment feature in a parked position;

FIG. 10 is a quartering perspective view from below of the load floor positioned as an upper shelf; and

FIG. 11 illustrates an alternate embodiment of the load floor (in which the load floor is hinged and edges may extend from a portion thereof to enable the load floor to be supported between quarter trim panels).

### DETAILED DESCRIPTION OF THE PREFERRED EMBODIMENT(S)

One purpose of this invention is to provide a sliding load floor system in the cargo area of a vehicle that permits heavy cargo items to be loaded and unloaded ergonomically.

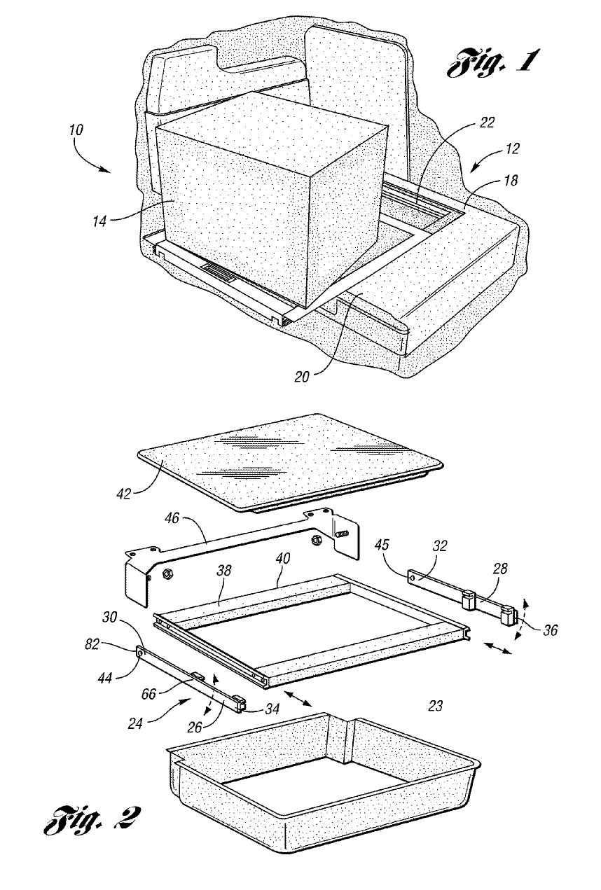

In FIG. 1, the rear cargo area 12 includes a pair of opposing side portions or quarter trim panels 14 (one shown) that extend longitudinally in relation to the length of the vehicle, a pair of opposing transverse portions 18, 20 that extend laterally, and a storage bin 22 positioned between and at a level below the plane of the side and transverse portions.

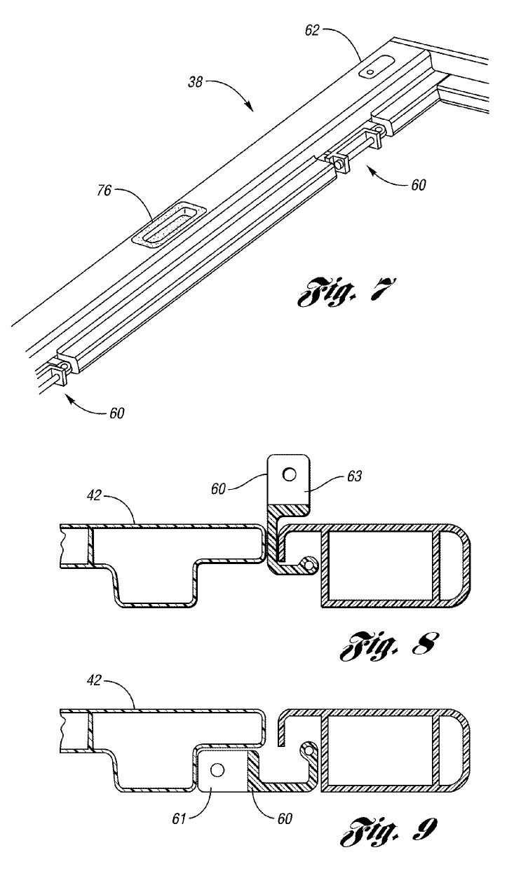

The sliding load floor system 10 disclosed herein includes a slide mechanism 24 (FIG. 2), or other linear bearing or linear motion system. The slide mechanism 24 includes a pair of opposing rail members 26, 28. Each rail member has a forward edge 30, 32 and a rearward edge 34, 36. A frame 38 is slidably received by the slide mechanism. Preferably, the frame 38 can be removed, if desired, to allow unfettered access to any underlying storage area, so that the storage bin 22 can itself serve as a cargo area. In one embodiment, the slide mechanism 24 includes aluminum extruded rail with cast metal attachment block having nylon liners. Alternatively, the rail members 26, 28 may be formed from rolled steel with steel ball bearings, or equivalent structures. One source for suitable such systems is the Igus Company. As depicted in FIGS. 5-6, the load floor 42 is supported by a cross member 14 that extends from a side frame of the vehicle.

Detachably attached to the frame 38 is a removable load floor 42. Optionally, a mounting bracket 46 may be provided. A hinge assembly is mounted to the side portions of the rear cargo area. The forward edges 30, 32 of the rail members 26, 28 are connected to the hinge assemblies. In one embodiment, the connection is provided by a pin or bolt, for example, that hingedly connects a forward edge 30, 32 directly to the associated hinge assembly 82 (left hand side shown only). In this way, the slide mechanism 24, the frame 38 and the removable load floor 42 may be swung upwardly about the forward edges 30, 32. Then the frame plus the load floor can be slid rearwardly, thus allowing access to a spare tire or storage area below.

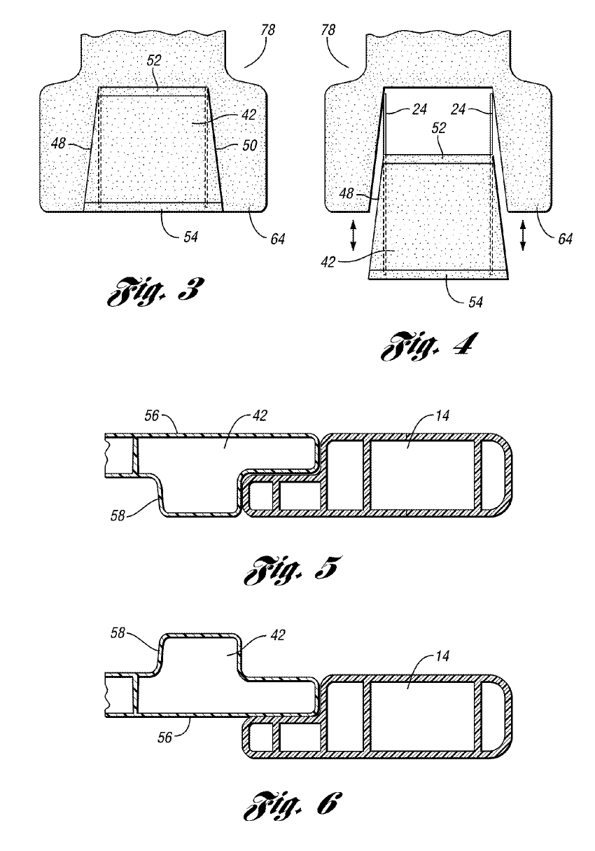

As shown in FIGS. 3-4, a further aspect of the panel 42 is that its side edges lie at an angle to one another, but are symmetrical in relation to the center line of vehicle, so that the forward edge 52 of the panel is narrower than the rear edge 54 (near the wheel wells 78). This allows the panel 42 to directly abut the surrounding floor panels when closed, providing a well crafted appearance. If the edges were parallel, a generous gap (15 mm per side) would be needed to allow a low effort sliding under all build tolerance conditions.

Preferably, as illustrated in FIGS. 5-6, the load floor or panel 42 is a reversible, blow molded panel that is removably retained within the frame 38. In one embodiment, the floor has a carpeted surface 56 on one side for a continuous floor appearance and a molded floor surface 58 on the other side to serve as a washable surface, and to provide some support for cargo.

This panel 42 can be removed for installation at a different position in the vehicle, for instance as a higher shelf. Optionally, extension legs (FIG. 10) extend from the underside or lateral edges of the panel to gain extra width, when deployed, for installation between trim panels that may be spaced apart wider than the panel.

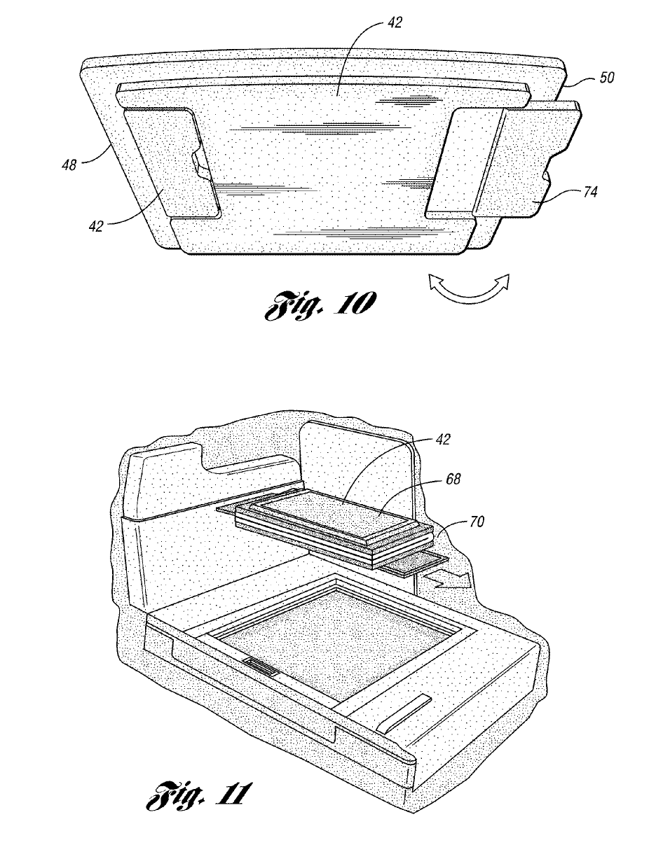

In other embodiments (FIGS. 7-9), bicycle fork retainers are concealed beneath the removable panel 42. They extend from the frame 38 and can be rotated upwardly (FIGS. 8-9) when needed. Replacing the panel (FIG. 9) holds them in place. It will also be appreciated that the disclosed bicycle attachment mechanism 60 is one example of a tie down system that may be fixed or adjustable. One provider is Transporters Bike Carrying System (the bike hitch Pro Model), Yakima and Thulé. The disclosed system exemplifies an embodiment in which two bicycles can be retained. The rear wheel of one bicycle is positioned forwardly in the vehicle while the bicycle forks are located towards the rear of the vehicle. Also, tie downs 62 can be provided in the frame 38, preferably at the corners, to secure cargo. These could take the form of rotatable loops so that, when not in use, a smooth surface is presented. If desired, a lift handle 76 (FIG. 7) can be provided to facilitate handling of the frame 38.

In one embodiment, the system has an installed height of approximately 50 mm. The surrounding floor panels 64 (FIGS. 3-4) can be hinged or removable, serving as alternatively configured lids over floor storage bins.

This invention thus provides a method for sliding heavy cargo items in and out of a vehicle, while providing a relatively lightweight removable panel that can be moved to a different location.

It will be appreciated that the disclosed storage bin 22 is effectively a multipurpose sub-floor storage facility. It may include, for example, a box, a bin, a tray, or a multi-compartment rotatable storage tray, such as a “lazy susan”.

One advantage of the disclosed system is it provides easy access to sub-floor storage areas while presenting a flush appearance when in the closed position.

Optionally, the load floor system includes a locking feature 66 (FIG. 2) between the frame 38 and the slide mechanism 24 which secures the load floor 42 in fully or partially extended position. Thus, if the vehicle is parked on an incline, deployment of the load floor 42 in an intermediate position tends to avoid unwanted acceleration inwardly toward the vehicle of a heavy load because less inertia (mass×acceleration) will be involved.

Preferably, the disclosed system so configured as to eliminate buzz, squeal, and rattling concerns (“BSR” concerns). In use, the sliding floor may support a load of up to about 440 lbs. (200 kg) when in the fully retracted and extended positions. Maximum deflection is less than about 20 mm, and there is no permanent deformation following repeated use. The effort to fully extend and retract the sliding load floor is less than about 10 kgf when loaded with 440 lbs. (200 kg).

In one embodiment, the entire sliding floor load system weighs less than 9500 grams—including the load floor, the sub-floor storage unit, frame, slide mechanism, and tie down rails.

In another embodiment (FIG. 10), the removable load floor 42 includes side edges 72, 74 that may engage opposing sides of the rear cargo area so that the floor can be supported at a level above the frame. In such embodiments, multiple spring-loaded locking pins (not shown), for example, extend from side edges 48, 50 of the floor 42. When extended, the locking pins may be received by recesses where defined within the sides of the rear cargo area. In this way, the underside of the removable load floor 42 is equipped with extensions 72, 74 to allow it to be wide enough to bridge between opposing quarter trim panels 14.

If desired, the load floor system may be completely removed so as to make the entire sub-floor of the rear cargo area the storage base.

In an alternative embodiment, removable load floor 42 itself may include multiple panels 68 (FIG. 11) that can be connected by a hinge 70 having an axis that extends either longitudinally or laterally (as shown) in relation to the vehicle. Such embodiments may permit selective access to the underlying storage bin and other sub-floor areas.

One attribute of the hinged assembly 44 is that it permits the load floor 42 to be able to slide outwardly over a raised sill at the rear of some vehicles while maintaining a generally horizontal orientation.

Preferably, the vehicle should not be driven when the load floor 42 is either partially or fully extended. If desired, a mechanism can be provided whereby an annunciator (located, perhaps on the instrument panel,) becomes illuminated if a forward or reverse gear is selected when the load floor is not in its fully retracted position. Additionally or alternatively, such a condition could be communicated via a signal to an actuator that precludes movement of the vehicle until the load floor is slid forwardly and engaged in that position.

Thus, the disclosed system provides a structure (preferably metallic frame 38) that handles load carrying needs. The removable load floor 42 offers the versatility to meet a variety of cargo management needs. The slide mechanism 24 at each side of the system ensures a smooth, low effort movement while extending the load floor of the vehicle. If desired, a storage bin 22 may be provided to handle storage needs below the sliding load floor 42.

Another sliding load floor system is disclosed in U.S. patent application Ser. No. ______ dated ______ which is filed on the same day as the present application. Another application disclosing a load floor system was also filed on the date of filing the present application. Its serial number is Ser. No. ______. Each of these two applications are included herein by reference.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A sliding load floor system for use in the rear cargo area of a vehicle, the cargo area having a pair of opposing side portions that extend longitudinally in relation to the center line of the vehicle, a pair of opposing transverse portions that extend laterally in relation to the vehicle, and a storage area positioned between and at a level below a plane including the side and transverse portions, the sliding load floor system comprising:
a slide mechanism including a pair of opposing rail members, each rail member having a forward edge;
a frame that is slidably received by the rail members of the slide mechanism, the frame having a front edge;
a removable load floor that is detachably positioned in relation to the frame; and
a hinge assembly that is mounted to the side portions, the forward edges of the rail members being connected to the hinge assembly so that the slide mechanism, the frame and the removable load floor may be displaced upwardly in relation to the hinge assembly, and the frame plus the load floor slid rearwardly and/or arcuately about the hinge assembly.

2. The sliding load floor system of claim 1 wherein the front edges of the rail members can be displaced upwardly in relation to the hinge assembly, thereby elevating to a level at which the removable load floor can be slid outwardly in relation to the vehicle.

3. The sliding load floor system of claim 1 wherein the hinged assembly has a first pivot access which permits upward displacement of the front edge of each rail member and a second pivot access about which the rail members may remove arcuately, thereby altering the inclination of the removable load floor.

4. The sliding load floor system of claim 1, further including a locking mechanism whereby the hinge assembly can be secured at an interim position or a final position, thereby securing the frame and the load floor.

5. The sliding load floor system of claim 1 wherein the removable load floor has tapered edges so that the front edge of the removable load floor is shorter than the rearward edge, so that the load floor can be slid inwardly and outwardly with minimal effort and so that in its retracted position, a flush-fit appearance is presented.

6. The sliding load floor system of claim 1 wherein the removable load floor has a carpeted surface on one side, and a contoured surface on its other side, the removable load floor being reversible.

7. The sliding load floor system of claim 6 wherein a side frame member extends from each side of the cargo area of the vehicle, the removable load floor being supported between the side frame members.

8. The sliding load floor system of claim 1 wherein the frame includes one or more attachment members that may secure a bicycle.

9. The sliding load floor system of claim 8 wherein each attachment member may be moved between a deployed position and a parked position after the removable load floor is moved away therefrom.

10. The sliding load floor system of claim 1 wherein the removable load floor has a pair of side edges that may be extended outwardly therefrom to permit an abridging relationship between the removable load floor and the side members of the vehicle and so that the load floor may be positioned at an elevation above the lower level of the cargo area.

11. The sliding load floor system of claim 1 wherein the removable load floor includes one or more panels and a hinged member that lies therebetween.

12. The sliding load floor system of claim 11 wherein one or more of the panels has a pair of side members that may extend therefrom and engage the side portion of the vehicle, thereby supporting the one or more panels of the load floor.

13. A cargo management system for use in a vehicle, the vehicle having a rear cargo area, a pair of opposing side portions, a pair of opposing transverse portions, and a storage area, comprising the steps of:
installing a slide mechanism with a pair of opposing rail members, each rail member having a forward edge;
attaching a frame so that it is slidably received by the rail members of the slide mechanism, the frame having a front edge;
detachably positioning a removable load floor in relation to the frame; and
mounting a hinge assembly to the side portions so that the forward edges of the rail members are connected to the hinge assembly, thereby enabling the slide mechanism, the frame and the removable load floor to be displaced upwardly in relation to the hinge assembly, and the frame plus the load floor slid rearwardly and/or arcuately about the hinged assembly.
